(19) United States
(12) Patent Application Publication
(10) Pub. No.: US 2006/0075354 A1
(43) Pub. Date: Apr. 6, 2006

(54) Experience digitally recorded book

(76) Inventor: Elizabeth Harpel, Coppell, TX (US)

Correspondence Address: Friederichs Law Firm, 6421 Kurtz Lane, Eden Prairie, MN, 53737, US

(21) Appl. No.: 10/957,900

(22) Filed: Oct. 5, 2004

(51) Int. Cl. G06F 3/00

(52) U.S. Cl. 715/776

(57) ABSTRACT

Disclosed is software and a method that has the following steps: inputting a text book into a data base for sequential display onto a computer screen; programing the data display, the data for sequential display of experiences; the sequential display of experiences comprises story text and movie clips associated with said story text material; the speed at which one must read the text material may be controlled and the text may be speeded up or slowed down; the speed of the movie clip is held at a constant whereas the text speed of the display may be controllably varied; the text material is combined with narration; the text material is read by the narrator simultaneously as the text is displayed; the control is by a first software which is contained on a first disc and the story data and the movie clip is contained on a second disc.

### FIELD OF THE INVENTION

The present invention relates to an electronic digitally recorded book and more particularly to a video reading novel with selective reading speed and moving images.

### DESCRIPTION OF THE PRIOR ART

The prior art shows electronic books. For example, U.S. Pat. No. 6,525,706 (Rehkemper et al) ELECTRONIC PICTURE BOOK discloses an electronic picture book including a plurality of pages graphically telling a story with a plurality of buttons. Depression of the correct button provides animation sequences and sounds indicative of the graphic representations on the page. This patent does not combine the moving images with the text. Also, this patent does not disclose concept of selective variable reading speed.

U.S. Pat. No. 6,154,214 (Uyehara et al) DISPLAY ORIENTATION FEATURES FOR HAND-HELD CONTENT DISPLAY DEVICE discloses an electronic reading system that permits a person to download books from Internet sites to a hand-held reader device.

US Patent Pub. No. 20030071800 (Vincent et al) PORTABLE ELECTRONIC READING APPARATUS discloses an electronic book that employs an electronic field addressable, i.e., rewritable and colorant.

U.S. Pat. No. 5,697,793 (Huffman et al) ELECTRONIC BOOK AND METHOD OF DISPLAYING AT LEAST ONE READING METRIC discloses an invention that has functional and structural discloses a method for calculating reading speed. Huffman et al reference does not illustrate selectively, varying the reading speed.

U.S. Pat. No. 6,229,502 (Schwab) ELECTRONIC BOOK discloses a method for calculating the reading speed, Schwab does not disclose selectively varying the reading speed.

### SUMMARY OF THE PRESENT INVENTION

The software and method of the present invention has the following steps: inputting a text book into a data base for sequential display onto a digital display screen. Programing the data display for sequential display of experiences. The sequential display of experiences comprises story text and non-verbal movie clips associated with said story text material. The movie clips may serve the purpose of motivation to the reader. The speed at which one reads the text material can be controlled and may be speeded up or slowed down. There may be a read-out of the words per minute (wpm) that the words are presented at. The speed of the movie clip is held at a constant whereas the text speed of the display may be controllably varied. The text material is combined with narration. The text material is read by the narrator simultaneously as the text is displayed. The control is by a first software contained on a first disc and the story data and the movie clip is contained on a second disc.

The present invention provides a Windows-based software application which utilizes supported formats with higher-density data storage and larger data capacity to deliver each book. The present invention provides a hand-held device (hardware) to use specifically with DVRDs and both software applications. The designation DVRD as used herein means any digital recording that includes text and interest generating moving depiction wherein the text display is speed controlled and variable. The present invention is a DVRD, not just an electronic book. It is a unique presentation of text integrated with a narrator, music, video clips and graphics combined to tell a story. The present invention comprises an electronic book that includes text and moving images integrated with the text. The invention includes steps of inputting a text book into a data base for sequential display onto a computer screen, programing said data display for sequential display of experiences. The present invention further includes a sequential display of experiences comprises story text and movie clips associated with said story text material. The present invention wherein the speed at which one must read the text material can be controlled and the text material may be speeded up or slowed down. In the invention, the speed movie clip may be held at a constant wherein the speed of the text may be controllably varied.

For example, in one embodiment the text book is about a girl that studies the violin. The girl improves playing better and better. The reader goes with the girl to her violin lessons as she starts out playing Twinkle Twinkle Little Star, eventually ending up with beautiful rendition of Konon by Pachelbel. Finally, the girl gets to try-out with the Boston Pops Orchestra playing the Ave Maria by Schubert. The reader goes with the girl to each of experiences with combinations of reading and moving images and sound.

A unique format is used to distribute enhanced electronic books into the technology age. The end-user has the ability to speed the narrator up or down, which will in turn increase the scrolling speed of the text while the related music, video and graphics, proceeds at a their normal constant speed. This is designed to work with the different reading speeds of different readers. The end-user has the ability to turn the narrator on or off, which does not turn the music on or off. The end-user has the ability to turn the narrator volume up or down. The end-user has the ability to wear headphones plugged into the device to hear the music and narrator, if so desired. Although, without the audio/narrator, the end-user can read the book at their desired speed, but will miss part of the dynamics of the design. The end-user has the ability to move forward or backward to other pages.

### DETAIL DESCRIPTION OF PRESENT INVENTION

The method of the present invention includes the steps of inputting a text book into a data base for sequential display onto a computer screen; programing the data display, the data for sequential display of experiences; the sequential display of experiences comprises story text and non-verbal movie clips associated with the story text material; the speed at which one must read the text material may be controlled and the text may be speeded up or slowed down; the speed of the movie clip is held at a constant whereas the text speed of the display may be controllably varied; said text material is combined with narration; said text material is read by the narrator simultaneously as the text is displayed; the control is by a first software contained on a first disc and the story data and the movie clip is contained on a second disc. The method may include the following steps of inputting a text book into a data base for sequential display onto a computer screen and programing the data display, and the data for sequential display. The data base may be a DVRD and will be described with regard as such.

The Reader software application may be an integrated Windows-based application, compatible with any IBM compatible PCS, notebooks, and hand-held devices using DVRDs to deliver a unique format/style of enhanced electronic book. With the software application loaded, any end-user will be able to insert a DVRD with the desired book title into the hardware device's DVD drive to open the software application and enjoy the new technological techniques used to enhance what would otherwise be just an electronic book.

Upon insertion of the DVRD, the programming code stored on the DVRD will automatically work in combination with the programming code in the software application loaded on the hardware device to open the software which is then used to open the book. From the Title Page on, the end-user will see the same page format as in a book, but enhanced with graphics, video, music and narrator/volume which change with the story and control buttons which control certain characteristics of the application.

All control buttons/functions—volume, on/off, previous/next controls shown on each page will not change from one book to the next. These are characteristics of the software application and will only change from one version to the next.

The Book may have following formate: 1) Title Page Acknowledgments 2) Preface; 3) Table of Contents; 4) References; 5) Index and 6) All with page numbers and references as required. The reader has the ability to electronically bookmark their place to come back to the next time they begin reading. The end-user does not have the ability to make any editorial changes to the text, music, video clips, or graphics. The Reader software application is an integrated Windows-based application, compatible with any IBM compatible PCS, notebooks, and hand-held devices using DVRDs to deliver a unique format/style of enhanced electronic book. With the software application loaded, any end-user will be able to insert a DVRD with the desired book tied into the hardware device's DVD drive to open the software application and enjoy the new technological techniques used to enhance what would otherwise be just an electronic book.

Upon insertion of the DVRD, programming code stored on the DVRD will automatically work in combination with programming code in the software application loaded on the hardware device to open the software which is then used to open the book. From the Title Page on, the end-user will see the same page format as in a book, but enhanced with graphics, video, music and narrator/volume which change with the story and control buttons which control certain characteristics of the application.

All control buttons/functions—volume, on/off, previous/next controls shown on each page will not change from one book to the next. These are characteristics of the software application and will only change from one version to the next. The reader has the ability to electronically bookmark their place to come back to the next time they begin reading. The end-user does not have the ability to make any editorial changes to the text, music, video clips or graphics. The initial software purchase will be packaged with one book title. All other book titles will be sold separately or in sets.

The reader software application is an integrated Windows-based application, compatible with any IBM compatible PCS, notebooks, and hand-held devices using DVRDs to deliver a unique format/style of enhanced electronic book. With the software application loaded, any end-user will be able to insert a DVRD with the desired book title into the hardware device's DVD drive to open the software application and enjoy the new technological techniques used to enhance what would otherwise be just an electronic book.

Upon insertion of the DVRD, programming code stored on the DVRD will automatically work in combination with programming code in the software application loaded on the hardware device to open the software which is then used to open the book. From the Title Page on, the end-user will see the same page format as in a book, but enhanced with graphics, video, music and narrator/volume which change with the story and control buttons which control certain characteristics of the application.

All control buttons/functions—volume, on/off, previous/next controls shown on each page will not change from one book to the next. These are characteristics of the software application and will only change from one version to the next.

The reader has the ability to electronically bookmark their place to come back to the next time they begin reading. The end-user does not have the ability to make any editorial changes to the text, music, video clips, or graphics. The initial software purchase will be packaged with one book title. All other book titles will be sold separately or in sets.

It is claimed:

1) The method comprising steps of:
inputting a text book into a data base for sequential display onto a computer screen;
programing said data display, said data for sequential display of experiences;
said sequential display of experiences comprises story text and non-verbal movie clips associated with said story text material;
the speed at which one must read the text material may be controlled and the text may be speeded up or slowed down;
the speed of the movie clip is held at a constant whereas the text speed of the display may be controllably varied;
said text material is combined with narration;
said text material is read by the narrator simultaneously as the text is displayed;
the control is by a first software contained on a first disc and the story data and the movie clip is contained on a second disc.

2) The method comprising steps of:
inputting a text book into a data base for sequential display onto a computer screen;
programing said data display, said data for sequential display of experiences.

3) The method of claim 2 wherein the sequential display of experiences comprises story text and movie clips associated with said story text material.

4) The method of claim 3 wherein the speed at which one must read the text material may be controlled and the text may be speeded up or slowed down.

5) The method of claim 4 wherein the speed of said movie clip is held at a constant whereas the text speed of the display may be controllably varied.

6) The method of claim 5 wherein the text is combined with narration.

7) The method of claim 5 wherein the text is read by the narrator simultaneously as the text is displayed.

8) The method of claim 7 wherein the control is by a first software contained on a first disc and the story data and the movie clip is contained on a second disc.

9) An electronic book comprising sequential pages of a novel, means for controlling the presentation of sequential pages of the novel, means for indicating the rate of words per minute of presentation of sequential pages of the novel, experiences recorded on movie clips interspersed at appropriate locations throughout the novel.

10. Software comprising means for:
inputting a text book into a data base for sequential display onto a computer screen; and
programing said data display, said data for sequential display of experiences.

11) The software of claim 10 wherein the sequential display of experiences comprises story text and movie clips associated with said story text material.

12) The software of claim 11 wherein the speed at which one must read the text material may be controlled and the text may be speeded up or slowed down.

13) The software of claim 12 wherein the speed movie clip is held at a constant whereas the text speed of the display may be controllably varied.

14) The software of claim 13 wherein the text is combined with narration.

15) The software of claim 14 wherein the text is read by the narrator simultaneously as the text is displayed.

16) The software of claim 15 wherein the control is by said first software contained on a first disc and the story data and the movie clip is contained on a second disc.
